(19) United States
(12) Patent Application Publication
(10) Pub. No.: US 2015/0274850 A1
(43) Pub. Date: Oct. 1, 2015

(54) METHOD FOR PRODUCING A POLYVINYL ACETATE DISPERSION

(71) Applicant: HENKEL AG & CO. KGAA, Duesseldorf (DE)

(72) Inventors: Oliver SOMMER, Duesseldorf (DE); Dagmar Wagenblasst, Porta Westfalica (DE); Hans-Juergen Wolter, Petershagen (DE); Anke Randall-Meineker, Luhden (DE); Ralf Gossen, Duisburg (DE); Werner Gottstein, Bopfingen (DE); Sebastian Kottoff, Porta Westfalica (DE)

(21) Appl. No.: 14/737,947

(22) Filed: Jun. 12, 2015

Related U.S. Application Data
(63) Continuation of application No. PCT/EP2013/076032, filed on Dec. 10, 2013.

(30) Foreign Application Priority Data
Dec. 14, 2012 (DE) 102012223211.7

(51) Int. Cl. C08F 2/20; C09J 11/04; C09J 4/00; C09J 9/00; C08F 2/18; C08F 2/44

(52) U.S. Cl. CPC C08F 2/20; C08F 2/18; C08F 2/44; C09J 4/00; C09J 9/00; C09J 11/04

(57) ABSTRACT

A method for producing an aqueous adhesive dispersion, wherein a dispersion is produced from a sheet silicate having an SiO₂ fraction and a hydrophobic ethylene/polyvinyl alcohol copolymer as protective colloid, and, in the presence of this dispersion, vinyl esters and optionally comonomers are polymerized.

### FIELD OF THE INVENTION

The invention relates to a method for producing an aqueous polymer dispersion containing fillers, wherein vinyl ester monomers are polymerised in the presence of a special filler and a selected polyvinyl alcohol as a protective colloid. The invention further relates to a polyvinyl acetate dispersion that can be obtained in this way and to the use thereof as an adhesive.

### BACKGROUND OF THE INVENTION

EP 1188775 A2 describes a method for producing aqueous polyvinyl ester resin dispersions by emulsion polymerisation of vinyl ester monomers in the presence of polyvinyl alcohol as a protective colloid and water-insoluble compounds containing hydroxyl groups. No fillers are present during the polymerisation.

EP 1493793 A1 describes dispersions that are produced by way of polymerisation in the presence of polyvinyl alcohols. These are used as an adhesive. They do not contain any pigments.

EP 2138548 A1 describes an aqueous dispersion on the basis of vinyl acetate copolymers which are produced in an aqueous solution. These are produced in the presence of specially selected polyvinyl alcohols. In this document, reference is made to the difficulties involved in producing adhesive layers that are stable in water from the dispersions thus prepared. It is not described to carry out the polymerisation in the presence of special fillers. In as far as fillers are necessary, these are usually added to the dispersions during the production of adhesive formulations therefrom.

WO 2008/122297 A1 describes an aqueous dispersion containing pigments and fillers, as emulsifiers surfactants and polyvinyl alcohol, wherein only standard polyvinyl alcohols (PVOH) are used. No special non-polar polyvinyl alcohol derivatives are described. Further, in particular SiO₂ is described as a pigment.

DE 102010039319 A1 discloses coating agents on the basis of one or more mineral binders, one or more polymers, one or more fillers and optionally one or more additives, wherein these contain 2 to 30% by weight of lime. Amongst a multiplicity of possible additives, sheet silicates and optionally hydrophobically modified polyvinyl alcohols are mentioned. However, it is not mentioned to add special sheet silicates and special hydrophobically modified polyvinyl alcohols during the production of the polymers.

From DE 102008043988 A1, fibrous mortar compositions are known. These contain binders, a filler, optionally additives, fibres and re-dispersion powders. Again, amongst a multiplicity of possible additives, sheet silicates and optionally hydrophobically modified polyvinyl alcohols are mentioned. However, it is not mentioned to add special sheet silicates and special hydrophobically modified polyvinyl alcohols during the production of the polymers (re-dispersion powders).

DE 19962568 A1 describes polyvinyl alcohol-stabilised 1,3-diene-(meth)acrylic acid ester mixed polymerisates. These are produced by way of emulsion polymerisation in the presence of a polyvinyl alcohol as a protective colloid. The presence of a filler during the polymerisation is not intended. Fillers, as well as other desired additives, may be admixed to the polymer dispersion after the production thereof.

DE 10329594 A1 discloses the use of ethylene/polyvinyl alcohol copolymers as a protective colloid during the production of polyvinyl acetate dispersions. There are no fillers present during the polymerisation.

It is known that dispersions that are mixed with pigments and/or fillers are less storage-stable because any retrospective dispersion of the pigments and/or fillers in the binder dispersion is difficult. Since a number of pigments act at the same time as fillers and many inorganic fillers are also pigments, the terms pigment and filler will be used synonymously herein below. The problem of reduced storage stability is especially also present if polymerisation takes place in the presence of the pigments. The storage stability of such pigmented (filler-containing) dispersions is a problem. Frequently, a sediment of precipitated pigments and polymers quickly forms. Such dispersions cannot be stirred back up again because the settled substances stick together and cannot be finely dispersed again. It has further been found that filler dispersions result, due to the formation of dissolved metal ions, in dispersions with only poor storage stability. However, in principle, pigments and/or fillers in aqueous adhesives may have application-related advantages. They can evoke a barrier effect of the layer, they change the rheological flow behaviour, and they can modify the adhesive force of a dispersion. For this reason, filler-containing dispersions are of interest irrespective of the disadvantages mentioned.

It has frequently been shown that an adhesion with aqueous polymer dispersions under humid ambient conditions is not stable. EP 2138548 describes the problems that may occur during the production and adhesion with PVOH dispersions in detail.

It is therefore the object of the present invention to provide a method for producing storage-stable filler-containing aqueous polyvinyl ester dispersions and adhesives that are based thereon. The obtained dispersions and adhesives are to have a long shelf life, a suitable application viscosity and are to result in a very stress-resistant adhesion. This adhesion is to remain stable also in a humid environment.

### SUMMARY OF THE INVENTION

The invention relates to a method for producing an aqueous adhesive dispersion, wherein a dispersion of fillers and protective colloids is produced, and vinyl esters and optionally comonomers are polymerised in the presence of this mixture, wherein hydrophobic ethylene/vinyl alcohol copolymers are used as a protective colloid, and sheet silicates are used as a filler, which contain SiO₂ fractions.

The invention further relates to an aqueous dispersion that may be obtained using this method, as well as the use of the dispersion as an adhesive for gluing wood.

### DETAILED DESCRIPTION OF THE INVENTION

Methods for producing dispersions are known in different embodiments. For example, surfactants, emulsifiers and other dispersion additives are dissolved in an aqueous phase. Subsequently, the monomer composition is introduced therein and polymerisation is carried out.

According to the method according to the invention, (co)polymerisates made from vinyl esters and optionally olefinically unsaturated comonomers are produced as adhesive binders. The polymerisation into these (co)polymerisates is carried out in the presence of special dispersed fillers. In particular, water-insoluble (co)polymers are produced in this way, which can be obtained by way of radical polymerisation of vinyl esters and optionally olefinically unsaturated comonomers.

Suitable as vinyl ester monomers for producing the copolymers are for example esters of the vinyl alcohol with C2 to C18 monocarboxylic acids, such as vinyl acetate, vinyl propionate, vinyl-n-butyrate, vinyl laurate and vinyl stearate. Preferably, vinyl acetate is used.

Suitable as olefinically unsaturated comonomers for producing the copolymers are radically polymerisable monomers such as for example ethylene; vinyl aromatic monomers such as styrene, a-methyl styrene or vinyl toluene; esters from a,6-unsaturated mono- and dicarboxylic acids preferably having 3 to 6 C atoms, such as in particular acrylic acid, methacrylic acid, maleic acid, fumaric acid and itaconic acid with C1 to C12 alkanols, such as acrylic acid and methacrylic acid methyl, ethyl, n-butyl, isobutyl and 2-ethylhexyl esters, maleic acid dimethyl esters or maleic acid-di-n-butyl esters or nitriles of α,β-unsaturated carboxylic acids such as acrylonitrile or mixtures thereof.

As preferred (co)polymers, polyvinyl esters of such olefinically unsaturated monomers are used which may be produced by way of emulsion or suspension polymerisation. These are for example vinyl ester monomers from linear or branched C2 to C12 carboxylic acids. Suitable copolymers may in particular consist of vinyl acetate and 0.1 to 50 mol %, in relation to the overall monomers, in particular 2 to 20 mol % of at least one mono- or diester of the fumaric, maleic, itaconic, crotonic, acrylic and/or methacrylic acid, wherein the ester group may be branched or non-branched and is to contain 2 to 18, in particular 4 to 8 C atoms. Terpolymers from the above-indicated comonomers are also suitable.

Also low amounts of monomers may optionally be included, which have at least one further functional group, such as epoxy, hydroxy, amine, N-methylol groups, or a further non-conjugated ethylenically unsaturated double bond. The amount of such monomers with further functional groups may amount to 0.1 to 10 mol %, in particular 0.1 to 5 mol % in relation to the amount of the monomers. By means of low amounts of di-functional monomers, also branched polymers may optionally be obtained. The amount of monomers containing polar or ionic groups is selected such that no copolymers which by themselves are soluble in water are obtained. However, the copolymers may additionally include monomers with functional groups, which may optionally crosslink after the application.

A further necessary component of the filler-containing polymer dispersion that can be produced according to the invention is the protective colloid, in the presence of which, together with the filler, the non-water-soluble polymer is polymerised.

The composition according to the invention contains at least one hydrophobic ethylene/vinyl alcohol copolymer as a protective colloid, for example a hydrophobic polyvinyl alcohol. Hydrophobic polyvinyl alcohols (PVOH) are understood to be polyvinyl alcohol copolymers which additionally contain ethylene building blocks in the polymer chain. In particular, the ethylene proportion may amount to 0.2 to 15 mol %. These copolymers are to be substantially hydrolysed with a degree of hydrolysis of more than 95%, so that at the same time hydrophobic and hydrophilic proportions are present in the polymer chain. The molecular weight of the suitable hydrophobic PVOH derivatives is preferably more than 30,000 g/mol, in particular more than 50,000 g/mol (determined via GPC against a polystyrene standard). Such polymers are commercially available.

According to the invention, it is necessary that 0.5 to 15% by weight, in particular up to 5% by weight (in relation to the overall weight of the dispersion), of protective colloid made from hydrophobic polyvinyl alcohols are included in the dispersion. A further embodiment uses a mixture of hydrophobic polyvinyl alcohol together with a standard fully hydrolysed polyvinyl alcohol. Here, the weight ratio between hydrophobic and fully hydrolysed may be between 1:5 and 5:1. If only polar PVOH compounds are used, the adhesion stability to water is reduced. If the hydrophobic proportion is too high, it is difficult to produce a dispersion together with the fillers.

It is possible to add in addition further protective colloids. These are for example starch ethers and/or cellulose ethers or the derivatives thereof, e.g. modified by oxidation, esterification, etherification or decomposition. Examples are hydroxyalkyl ether starches, hydroxyalkyl celluloses, carboxyalkyl celluloses, carboxyalkyl ether starches, dextrines or hydroxyalkyl dextrines.

A further component, which is added to the dispersion according to the invention as early as during the polymerisation reaction, is a special filler.

Fillers are understood to be, in terms of the invention, fillers, pigments, non-soluble dyes, but also solid, cross-linked, organic polymer powders. Suitable as fillers are for example inorganic substances that are inert to the polymers as well as during the production process of the filler-containing polymer dispersion under the reaction conditions prevailing there. Examples of suitable inorganic materials are silica, quartz powder, silica gel, barium sulphate, metal oxides such as zinc oxide, titanium dioxide, zeolites, kaophilite, leucite, the group of soro-, cyclo-, ino-, phyllo- and tectosilicates. Further suitable are compounds on the basis of sodium aluminium or calcium silicates. Also suitable are minerals such as aluminium silicates, for example andalusite, silimanite, kyanite, mullite, pyrophyllite, imogolite or preferably kaolinite. Water-sensitive or soluble fillers such as gypsum, anhydrite as well as calcium minerals like talcum or chalk are less suitable and should be avoided.

Further, in the context of the present invention, organic fillers in solid particulate form are suitable as fillers, in the presence of which polymerisation can take place. Suitable organic fillers are for example powdery, such as polyvinyl acetate, polystyrene, polyolefins on the basis of ethylene, propylene or butene; polyacrylonitrile, poly(meth)acrylate ester, polydialkyl maleinates and the copolymers thereof, as cross-linked or highly molecular solid substances. Individual fillers or mixtures may be used.

According to the invention, it is required here that at least one sheet silicate is present as a filler during polymerisation which contains SiO₂ fractions. In particular, aluminium silicates are suitable as sheet silicates. Especially preferably, these fillers have OH groups at the surface. An example of such an OH-containing sheet silicate is kaolinite. In their natural structure, these may contain a proportion of up to 75% by weight of SiO₂ as quartz. In particular, these are naturally occurring fillers. The proportion of such sheet silicates should amount to 25 to 100% by weight in relation to the overall filler amount, preferably to 60 to 100% by weight. Corresponding fillers are commercially available.

The filler particles and in particular the suitable sheet silicates should have a particle size (D₅₀ value) for example of approx. 0.1 to approx. 10 μm, for example approx. 0.5 to approx. 5 μm. It is preferred if more than 90% of the particles have a size of less than 10 μm. Within the context of the present invention, the classification of the particle size is based on the size of the primary particles. The measurement of the particle size is carried out by light diffraction; the D₅₀ value is the value at which 50% of the particles are smaller than the indicated diameter.

The amount of fillers present in the method according to the invention and in the dispersions obtained thereby preferably amounts to 2.5 to 75% by weight in relation to the overall weight of the dispersion, in particular 10 to 40% by weight.

Depending on the desired properties of the dispersion and the type of production, the proportion of the polymers in the overall adhesive dispersion may be in a range of 5 to 60% by weight. In a preferred embodiment of the invention, the proportion is 10 to 35% by weight.

The dispersion that can be obtained according to the invention can further contain up to approx. 20% by weight of additives in relation to the overall weight of the dispersion. The additives include for example stabilisers, defoamers, antioxidants, photostabilisers, pigment distributors, cross-linking agents, pH regulators, adhesion promoters, plasticisers, dyes, odorants and biocides. These may be added to the adhesive dispersion before or after the polymerisation of the vinyl ester and the comonomers, an addition after polymerisation being preferred.

As a preservative, advantageously benzoates, fluorides such as sodium fluoride, amidic substances and hydroxy benzoic acid esters may be added. As further additives, the adhesive dispersion according to the invention may include up to 2% by weight, preferably 0.1 to 1% by weight, of UV stabilisers. Particularly suitable as UV stabilisers are the so-called HALS compounds. For example, the adhesive dispersion according to the invention may also include proportions of plasticisers or tackifying resins. Suitable as plasticisers are for example esters of fatty acids carrying OH groups or being epoxidised, glycolic acid esters, phosphoric acid esters, phthalic acid esters, sebacic acid esters, sulfonic acid esters, trimellithic acid esters, citric acid esters, as well as mixtures thereof. Suitable as tackifying resin are for example hydrocarbon resins such as terpene resins, coumarone/indene resins; aliphatic petrochemical resins; hydrocarbon resins on the basis of unsaturated CH compounds or modified phenol resins or colophonium resins and derivatives. Suitable as adhesion promoters are in particular silanes containing hydrolysable groups such as alkoxy or acetoxy silanes. These may also additionally contain functional alkyl substituents. Examples are alkylamino, hydroxyalkyl or epoxyalkyl silanes. The amount may be from 0.1 to 3% by weight.

In a particular embodiment, the dispersion contains less than 0.5% by weight of anionic, amphoteric or cationic surfactants. In particular, the dispersion is free of surfactants. In a further preferred embodiment, the dispersion may contain 0 to 5% by weight, in particular 0.3 to 3% by weight of an acidic metal compound, for example aluminium, zinc, chromium or titanium compounds such as AlCl₃, Al(NO₃)₃, TiCl₄ or ZnCl₂.

All additives may be introduced immediately prior to the polymerisation, however it is also possible to add them after the production of the polymer/filler dispersion.

A preferred embodiment of the dispersion that can be obtained according to the invention contains 0.5 to 5% by weight of protective colloid made from hydrophobic ethylene/vinyl alcohol copolymer, 10 to 60% by weight of polyvinyl acetate copolymer, 10 to 40% by weight of sheet silicate filler, as well as 0.1 to 10% by weight of additives. In particular, the above-mentioned additives such as adhesion promoters, catalysts and/or stabilisers are included. In this context, the water content is to amount to 35 to 65% by weight and the sum of the constituents is to amount to 100% by weight.

The filler-containing polymer dispersion is produced, within the context of the present invention, by way of emulsion polymerisation. To this end, a dispersion of the filler particle is preferably initially produced in water. In this context, for example, initially an aqueous solution of the hydrophobic protective colloid is produced. This solution or dispersion is then homogenised, which can also be supported by heating. It is expedient if the pH value of the dispersion is between 3.0 and 7.0.

As the next method step, the dispersion of the filler particles is carried out. To this end, the filler particles are distributed in the above-indicated dispersion, wherein the dispersion is dispersed until the present filler agglomerates have been distributed to the maximum extent possible. Dispersing can be carried out by means of high-speed stirrers such as dissolvers. The breaking up of the agglomerates can optionally be influenced by changing the temperature or the stirring speed. By measuring the particle size distribution, the entire dispersion can be checked. However, also any other form of dividing the filler particle agglomerates into the primary particles is possible within the context of the method according to the invention. This includes for example breaking up agglomerates by means of ultrasound or by means of a static mixer.

Once sufficient dispersing of the filling particles has been achieved, the emulsion polymerisation is subsequently carried out. To this end, for example one part of the monomers is added, and once a part of suitable initiators has been added, the polymerisation is initiated by heating. Subsequently, the remaining proportions of monomers and initiator can be added in a dropwise manner whilst controlling the reaction temperature.

As polymerisation initiators for the preferably radical aqueous emulsion polymerisation, all those are suitable that are capable of triggering a radical aqueous emulsion polymerisation in the presence of the filler. These may be organic and inorganic initiators which are per se known, such as organic or inorganic peroxides, azo compounds or suitable redox initiators. For example, hydrogen peroxide, sodium persulfate, potassium persulfate or ammonium persulfate in amounts of up to 2.0% by weight, preferably in amounts of up to 0.2% by weight, are suitable. Such initiators are known to a person skilled in the art.

In order to obtain a complete reaction and to reduce the content of residual monomers, it is possible in one embodiment to add additionally, at the end of the reaction, also an optionally different initiator and to carry out a post-reaction due to elevated temperature.

Further additives may be added to the filler-containing polymer dispersion thus produced either after cooling or still at high temperature. These may be selected so as to influence certain properties of the finished adhesive dispersion. If these additives do not interfere with the polymerisation reaction, these may optionally be incorporated even as early as together with the protective colloid and the filler.

According to the production method, a storage-stable dispersion is obtained, which optionally can be used as an adhesive after adding further additives. Preferably, the adhesive dispersions according to the invention have a viscosity of less than 20,000 mPas, in particular from 5,000 to 15,000 mPas (ISO 2555, Brookfield RVT, spindle 4 for viscosities of up to 10,000 mPas, and spindle 5 for viscosities of more than 10,000 mPas, 25° C.). This dispersion should be storage-stable over a period of time of at least 8 weeks, i.e. no settled (filler) particles should be present at the bottom. In this connection it is also possible to reduce the viscosity of the dispersion for application using water or additives, for example to 2,000 to 15,000 mPas (25° C.), in particular to less than 5,000 mPas.

The advantage of the composition that can be obtained according to the invention is the enhanced stability of an adhesion against humidity. In this context, sample bodies are stable over a longer period of time in respect of their mechanical properties. As a result of the method according to the invention, also polymers including non-polar proportions may be used as dispersion additives; the resulting filler-containing dispersions are not self-dispersible, but still storage-stable. An increased amount of polar additives can here be avoided; these would lead to a degradation of the adhesion stability.

### EXAMPLES

Unless otherwise specified, all percentages indicated relate to % by weight.

In a high-speed stirrer, a pre-emulsion was produced, under heating to 70° C., from:

| Example 1 | | Example 2 | | |
|---|---|---|---|---|
| 40.0 | g | 37.5 | g | distilled water |
| 1 | g | 1 | g | fully hydrolysed polyvinyl alcohol |
| | | | | (4% by weight of aqueous solution |
| | | | | having a viscosity of 5,600 mPas) |
| 4.5 | g | 3.5 | g | ethylene/PVOH copolymer |
| | | | | (molecular weight approx. |
| | | | | 60,000 g/mol, >98% saponified) |
| 0.02 | g | 0.02 | g | defoamer. |

Subsequently, the following was added and dispersed under stirring:

| | | |
|---|---|---|
| 15 g | 0 | chalk |
| 15 g | 30 g | kaolinite (approx. 30% sheet silicate, |
| | | 70% quartz, containing OH groups) |
| 0.1 g | 0.1 g | tartaric acid |
| 0.5 g | 1.5 g | distilled water. |

After mixing, initiator solution and monomer mixture was added over a period of time of two hours at a temperature of approx. 75-80° C.:

| | | |
|---|---|---|
| 15 g | 15.5 g | vinyl acetate |
| 0 | 0.5 g | N-iso-butoxy-methylacrylamide |
| 5 g | 5 g | water, in which 0.15 g of H₂O₂ are dissolved. |

After 30 min at 80° C., the following was added under stirring in separate stages (in each case after 15 min):

| | | |
|---|---|---|
| 0.5 g | 0.5 g | distilled water with 0.05 g of tert-butyl hydroperoxide |
| 2.6 g | 1.6 g | water with 0.05 g of ascorbic acid |
| 0.5 g | 0.5 g | water with 0.5 g of H₂O₂. |

After further 10 min, the dispersion was cooled. Subsequently, a stabiliser solution was added, comprising:

| | | |
|---|---|---|
| 0.15 g | 0.15 g | Acticide LA, diluted with water at a weight |
| | | ratio of 1:1 (biocide). |

After cooling, the batch was filtered.

Solid bodies approx. 49% by weight

Viscosity test 1: 9,500 mPas, 25° C.

Viscosity test 2: 8,000 mPas, 25° C.

In Example 1, 98.4% of dispersion 1 with approx. 1.3% of a plasticiser (DIBP) together with 0.2% of a biocide were homogenised together with some water to form an adhesive.

In Example 2, 89.4% of dispersion 2 were mixed with approx. 2.5% of a plasticiser (triacetin) together with 1.9% of AlCl₃, 1.8% of water and 0.15% of Na(HCO₃)₂. 0.3% of a biocide were admixed together with approx. 4% of water, and an adhesive dispersion was produced.

As comparison test 3, test 2 was reworked, with the proviso that the ethylene/PVOH copolymer was replaced with the same amount of partially saponified PVOH (PVA 17-88). Moreover, exclusively 20 g of chalk were used as a filler. The additives were added to this dispersion 3, analogously to Example 2, and were tested as Example 3 as an adhesive.

Viscosity: 12,000 mPas

Solid bodies: approx. 48%

Adhesives 1-3 were subjected to a plurality of standard comparison tests.

Solid wood gluing beech to beech

setting time when gluing HPL onto 18 mm chipboard and hardwood onto hardwood,

open time on 18 mm chipboard and hardwood,

heat resistance according to DIN 14257

water resistance according to DIN EN 204/205 D3 test.

Description of the Testing Methods:

a) Prior to the gluing of beech to beech, the wood is planed, preferably directly prior to gluing, a maximum of 3 hours prior to gluing. The adhesive is applied onto the surfaces to be glued from both sides. Care has to be taken that the growth rings on the edges of the wood to be glued show a herringbone pattern relative to each other, as described in DIN EN 204. The amount of adhesive is 150 g/m². After 90 seconds, the wood edges are joined together and are firmly interconnected using vices. Within 3 minutes, the pressure onto the adhesive joint is slowly increased using the vices. After 24 hours, the vices are removed, and after further 48 hours, the glued wood edges are planed. Immediately afterwards, the wood edges are separated in the adhesive joint using a chisel and the wood fracture or the wood fibre fracture is visually assessed. Very good adhesions show a wood fracture or a wood fibre fracture of 90-100 area %, still acceptable adhesions have a wood fracture or a wood fibre fracture of more than 50 area %.

b) In order to ascertain the setting time, materials stored under normal climatic conditions are produced:
chipboard having dimensions of 100×200×18 mm and HPL with the dimensions of 130×25×1 mm
beech boards having dimensions of 100×125×5 mm and beechwood strips of 115×25×3 mm.

50 g/m² of adhesive are applied onto one beechwood board by means of a doctor blade, and 4 beechwood strips in each case were placed thereupon. A pressure of 0.8 N/mm² is applied onto the adhesion using a hydraulic press. In order to ascertain the setting time, the pressing process is repeatedly interrupted for short periods of time in order to rip a beechwood strip off the beechwood board by hand. In doing so, the wood fibre fracture or the wood fracture is assessed. The setting time has been reached as soon as a medium strength with a wood fibre fracture or a wood fracture of 25 area % has been reached.

In the case of an adhesion of HPL onto chipboard, the method as described above is carried out, however the amount of adhesive applied is about 100 g/m² and 200 g/m². Thus, a total of 3 values are obtained for ascertaining the setting time.

c) For determining the open time, materials stored under normal climatic conditions are used. The dimensions of the wood materials are described under b). The amount of adhesive applied both onto the chipboard and onto the beechwood board is selected to be 100 g/m² and 150 g/m². The open time is reached when the adhesion of adhesive to the HPL strips or the beechwood strips is 15 to 40 area %, preferably 25 area %.

d) Test setup and test according to DIN 14257

e) Test setup and test according to DIN EN 204/205

Results:

| Test | Adhesive 1 | | Adhesive 2 | | Adhesive 3 | |
|---|---|---|---|---|---|---|
| Solid wood adhesion (area %) | 90-100 | | 70-90 | | 40-60 | |
| Setting time beech 150 g/m² | 20-25 | min | 20-25 | min | 20-25 | min |
| Setting time chipboard 100 g/m² | 2-4 | min | 3-5 | min | 4-6 | min |
| Setting time chipboard 200 g/m² | 5-7 | min | 7-10 | min | 8-11 | min |
| Open time beech 100 g/m² | 4-5 | min | 4-5 | min | 6-7 | min |
| Open time beech 150 g/m² | 5-6 | min | 5-6 | min | 7-8 | min |
| Open time chipboard 100 g/m² | 3-4 | min | 3-4 | min | 5-6 | min |
| Open time chipboard 150 g/m² | 6-7 | min | 6-7 | min | 8-10 | min |
| DIN 14257 | 9-10 | N/mm² | 8-9 | N/mm² | 3-5 | N/mm² |
| DIN EN 204 storage sequence D3.3 | 2.2-2.5 | N/mm² | 2.1-2.4 | N/mm² | 1.6-1.8 | N/mm² |

Further, stability was optically assessed. Comparison 3 shows first sedimentations after 7 days of storage at 25° C. The remaining samples were still stable after 2 weeks. The adhesion of the comparison test is lower immediately after the adhesion and also after exposure to humidity.

1. A method for producing an aqueous adhesive dispersion, wherein initially an aqueous dispersion of fillers and protective colloids is produced and subsequently vinyl ester and optionally comonomers are added to this dispersion and are polymerised, characterized in that as a protective colloid, at least one hydrophobic ethylene/polyvinyl alcohol copolymer and as a filler at least one sheet silicate containing SiO₂ fractions are used.

2. The method according to claim 1, characterized in that as a protective colloid, fully hydrolysed ethylene polyvinyl alcohol copolymer having an ethylene content of up to 15 mol % is used.

3. The method according to claim 1, characterized in that as a protective colloid, a mixture of at least one hydrophobic ethylene polyvinyl alcohol copolymer and at least one fully hydrolysed polyvinyl alcohol is used, in particular in a weight ratio of 1:5 to 5:1.

4. The method according to claim 1, characterized in that the dispersed sheet silicates have a D₅₀ value, determined using light diffraction, of less than 10 μm.

5. The method according to claim 1, characterized in that the SiO₂ fraction of the sheet silicate used amounts to up to 75% by weight.

6. The method according to claim 1, characterized in that a catalytically active acidic substance, in particular Al, Zn, Ti compounds, is added to the dispersion.

7. The method according to claim 1, characterized in that the copolymer includes functional groups selected from OH, epoxy, amine, and methylol groups.

8. A dispersion produced according to the method of claim 1.

9. The dispersion according to claim 8, characterized in that the adhesive dispersion consists of i) 10 to 40% by weight of fillers containing at least one sheet silicate containing an SiO₂ fraction, ii) 0.5 to 5% by weight of at least one hydrophobic ethylene polyvinyl alcohol copolymer, iii) 10 to 60% by weight of at least one vinyl acetate (co)polymer, iv) water as well as v) 0.1 to 10% by weight of at least one additive.

10. The dispersion according to claim 9, characterized in that the adhesive contains up to 3% by weight of an acidic metal compound as an additive.

11. The dispersion according to claim 8, characterized in that the dispersion has a viscosity of up to 20,000 mPas.

12. The dispersion according to claim 8, which is an adhesive for gluing wood.

13. A method for producing an aqueous adhesive dispersion comprising the steps of:
(a) forming a dispersion of a plurality of fillers and a protective colloid;
(b) adding a vinyl ester (co)monomer, and optionally an olefinically unsaturated (co)monomer, to the dispersion; and
(c) polymerizing the (co)monomers;
wherein the plurality of fillers is a sheet silicates that contain SiO2 fractions and the protective colloid is a hydrophobic ethylene polyvinyl alcohol copolymer.

14. The method for producing an aqueous adhesive dispersion of claim 13, wherein the adhesive dispersion comprises:
(i) 10 to 40% by weight of the sheet silicate that contain SiO2 fractions;
(ii) 0.5 to 5% by weight of the hydrophobic ethylene polyvinyl alcohol copolymer;
(iii) 10 to 60% by weight of the vinyl ester (co)monomer, which is a vinyl acetate (co)monomer; and
(iv) 0.1 to 10% by weight of an additive.
